(19) United States
(12) Patent Application Publication
(10) Pub. No.: US 2010/0117977 A1
(43) Pub. Date: May 13, 2010

(54) Fluorescent Display Tube And Fluorescent Display Device Having Touch Switch Portion

(76) Inventors: Tatsuya Yoshino, Chiba (JP); Minoru Hiraga, Chiba (JP); Klaus Heynen, Chiba (JP)

Correspondence Address: QUARLES & BRADY LLP, 411 E. WISCONSIN AVENUE, SUITE 2040, MILWAUKEE, WI, 53202-4497, US

(21) Appl. No.: 12/613,845

(22) Filed: Nov. 6, 2009

(30) Foreign Application Priority Data
Nov. 8, 2008 (JP) 2008-287307

(51) Int. Cl. G06F 3/041

(52) U.S. Cl. 345/173; 345/47

(57) ABSTRACT

In a fluorescent display tube having an electrostatic capacitor type touch switch portion on a front plate, a shield electrode is provided between a filament cathode and the touch switch portion. Electrons emitted from the filament cathode are prevented from irradiating on the touch switch portion and the touch switch portion and a neighbor thereof are prevented from being charged up, thereby an operation of the electrostatic capacitor type touch switch becomes stable.

### CROSS REFERENCE TO RELATED APPLICATIONS

This application claims priority to Japanese Patent Application No. 2008-287307 filed on Nov. 8, 2008, the contents of which are hereby fully incorporated by reference.

### STATEMENT REGARDING FEDERALLY SPONSORED RESEARCH

Not Applicable.

### BACKGROUND OF THE INVENTION

1. Field of the Invention

The present invention relates to a fluorescent display device having a touch switch portion.

2. Description of the Related Art

It is known that a fluorescent display tube in which electrons emitted from heated filament cathode are caused to impinge upon a phosphor covering a top wall of an anode, and to excite the phosphor to produce luminescence. The fluorescent display tube is used as a display in various electronic/electric devices and a vehicle. Signals to be displayed are normally inputted from a switch provided around the fluorescent display tube.

Recently, it has been required that the switch is formed on a part of an envelope composing the fluorescent display tube in view of downsizing of components, and design. As an example of such a structure, it is known that a fluorescent display device in which electrodes of a touch switch are arranged adjacent to an inner wall of a front panel which is a part of the envelope, and a detection-control part detects a change of electrostatic capacity between the electrodes to switch a display of the fluorescent display tube (For example, see Japanese Published Patent Application No. S58-5989).

A fluorescent display device having a conventional touch switch portion will be explained with reference to FIGS. 6 and 7. FIG. 6 is an exploded perspective view showing a conventional fluorescent display tube. FIG. 7 is a block diagram showing an electrical structure of the whole conventional fluorescent display. In FIG. 6, reference numeral 101 indicates a fluorescent display tube. This fluorescent display tube 101 includes an envelope 103 having a display window 102. This envelope 103 is composed of a substrate 105 on which a pattern display part 104 is formed, a side plate 106 extending vertically on an outer periphery of the substrate 105, and a front plate 107 overlapped with the substrate 105 to sandwich the side plate 106 with the substrate 105.

A NESA film as a transparent conductive film is coated on an inner wall of the front plate 107 to form a transparent switch electrode part 108. This transparent switch electrode part 108 is composed of a common electrode 108a and a plurality of opposite electrodes 108b separated from the common electrode 108a by an insulating part 109. A touch switch detecting part S is formed by this switch electrode part 108 and an outer wall 107a of the envelope 103.

Further, in an interior of the envelope 103 which is maintained in a high vacuum state, anodes 104a on which a phosphor is coated to compose the pattern display part 104, a plurality of control electrodes 110 covering top walls of the anodes 104a, and a filament cathode 111 disposed above the control electrodes 110 are encapsulated. The electrodes 104a, 110, 111 are respectively electrically connected to lead terminals 112, 112, 112 extended outward from the envelope 103. Components of the switch electrode part 108 are respectively electrically connected to the lead terminals 112 with connecting tongue pieces 113.

The common electrode 108a and the opposite electrodes 108b of the switch electrode part 108 are connected to a switch control circuit part 114 shown in FIG. 7. Outputs of the switch control circuit part 114 are connected to anodes 104a in the fluorescent display tube 101 and a display control part 115 for controlling electric current applied to the control electrodes 110. Because the common electrode 108a faces the opposite electrodes 108b with a gap of the insulating part 109, electrostatic capacity exists between the electrodes 108a, 109 to form a kind of capacitor.

The switch control circuit part 114 detects a change of the electrostatic capacity between a state that nothing touches the touch switch detecting part S and a state that a finger of an operator touches the switch detecting part S. Then, corresponding to an output of the switch control circuit part 114, a display of the pattern display part 104 is changed via the display control part 115. Thus, the fluorescent display tube 101, the switch control circuit 114, and the display control part 115 compose the fluorescent display device having a touch switch.

In FIG. 6, electrons emitted from the filament cathode 111 are irradiated on not only the pattern display part 104, but also the switch electrode part 108 and a neighbor on the inner wall of the front plate 107. When the electrons are charged in the switch electrode part 108 and the neighbor on the inner wall of the front plate 107, the electrostatic capacity of these areas are affected, and the switch control circuit 114 may wrongly detect the signal. Thus, there is a problem that a wrong display is displayed on the pattern display part 104 via the display control part 115.

Accordingly, in view of the problem in the fluorescent display device having a touch switch, an object of the present invention is to provide a fluorescent display tube having a touch switch to prevent the touch switch from detecting wrongly, and a fluorescent display device using the fluorescent display tube.

### SUMMARY OF THE INVENTION

In order to attain the object, according to the present invention, there is provided a fluorescent display device including: a fluorescent display tube having an envelope having a front plate with at least partially a display window, a filament cathode for emitting electrons, anodes on which a phosphor, which is excited and exhibits luminescence by an electron, is coated, said anodes being selectable corresponding to display data, a touch switch portion formed on an inner wall of the display window of the front plate, and a shielding electrode interposed between the filament cathode and the touch switch portion; a switch control part electrically connected to the touch switch portion for outputting the display data corresponding to an input from the touch switch portion; and a display control part.

According to another aspect of the present invention, there is provided a fluorescent display tube including: an envelope having a front plate with at least partially a display window; a filament cathode for emitting electrons; anodes on which a phosphor, which is excited and exhibits luminescence by an electron, is coated, said anodes being selectable corresponding to display data; a touch switch portion formed on an inner wall of the display window of the front plate for outputting a signal to a switch control circuit; and a shielding electrode interposed between the filament cathode and the touch switch portion.

In yet another aspect of the present invention, there is provided a fluorescent display tube including: an envelope having a front plate with at least partially a display window; a filament cathode for emitting electrons; anodes on which a phosphor, which is excited and exhibits luminescence by an electron, is coated, said anodes being selectable corresponding to display data; a touch switch portion formed on an inner wall of the display window of the front plate; a shielding electrode interposed between the filament cathode and the touch switch portion; and a switch control part electrically connected to the touch switch portion for outputting the display data corresponding to an input from the touch switch portion and a display control part disposed in the envelope.

Preferably, the shielding electrode is a mesh-shaped metallic electrode.

Preferably, the shielding electrode is fixed to the front plate at around the display window.

Preferably, the same electric potential as applied to the filament cathode or the lower electric potential than that applied to the filament cathode is applied to the shielding electrode.

Preferably, the touch switch portion is made of a stripe-shaped or mesh-shaped metallic thin film electrode.

Preferably, a dummy electrode electrically independent from the touch switch portion and covering the display window is formed around the touch switch portion.

Preferably, the electric potential of the dummy electrode is fixed to the predetermined electric potential.

Preferably, the touch switch portion includes four electrodes indented each other, and detects electrostatic capacity in a manner that the electrodes at both ends are in the same phase, and the other electrodes are in phases respectively shifted 120 degree.

These and other objects, features, and advantages of the present invention will become more apparent upon reading of the following detailed description along with the accompanied drawings.

### EFFECT OF THE INVENTION

In the fluorescent display device or the fluorescent display tube of the present invention, because the shielding electrode is interposed between the filament cathode and the touch switch portion, the electron emitted from the cathode is shielded by the shielding electrode, and the touch switch portion receives no charge. Therefore, the switch control circuit part 114 may not detect wrongly, and the pattern display part 104 may not display wrongly via the display control part 115.

Further, because the shielding electrode is a mesh-shaped metallic electrode, the shielding electrode can shield the electron without disturbing the display of the pattern display part 104.

Further, because the shielding electrode is fixed to the front plate at around the display window, a fixed part is not visible, and does not disturb the display of the pattern display part 104.

Further, because the electric potential of the shielding electrode is at the same or lower than that of the filament cathode, the electron is reflected by the electric field, and a shielding effect of the electron is improved.

Further, the touch switch portion is made of a stripe-shaped or mesh-shaped metallic thin film electrode. Because the metallic thin film electrode is widely used in an anode producing process of the fluorescent display tube, the touch switch portion is similarly produced in the anode producing process.

Further, because the dummy electrode covering the display window is provided around the touch switch portion, an outlook of the display window is even, and a light emitting state of the pattern display part 104 is even in the touch switch portion and the neighbor thereof.

Further, because the electric potential of the dummy electrode is fixed to a predetermined electric potential, the charge of the electron emitted from the filament cathode is surely prevented.

Further, the four electrodes indented each other can allow the switch to work properly under a condition that the effect of the charge is shielded by the shielding electrode.

### BRIEF DESCRIPTION OF THE DRAWINGS

FIG. 1 is a front view showing a fluorescent display tube according to an embodiment of the present invention;

FIG. 2 is a sectional view taken on line X-X of FIG. 1;

FIG. 3 is a view showing a physical relationship between a switch electrode and a phosphor pattern according to the embodiment of the present invention;

FIG. 4 is an explanatory view showing an operating principle of a electrostatic capacity type touch switch according to the embodiment of the present invention;

FIG. 5 is a front view showing the fluorescent display tube according to the embodiment of the present invention;

FIG. 6 is an exploded perspective view showing a conventional fluorescent display tube; and

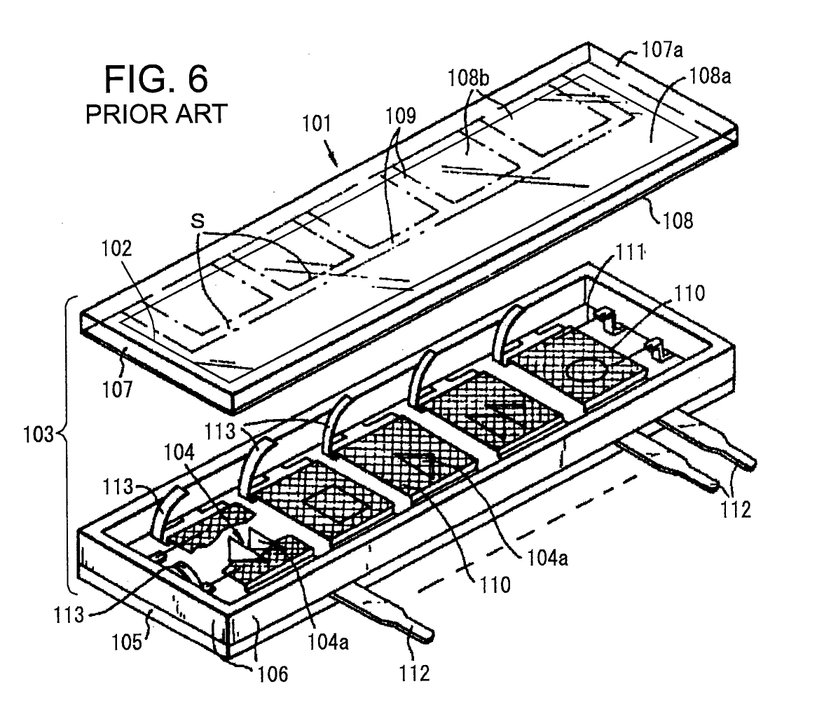

FIG. 7 is a block diagram showing an electrical structure of the whole conventional fluorescent display.

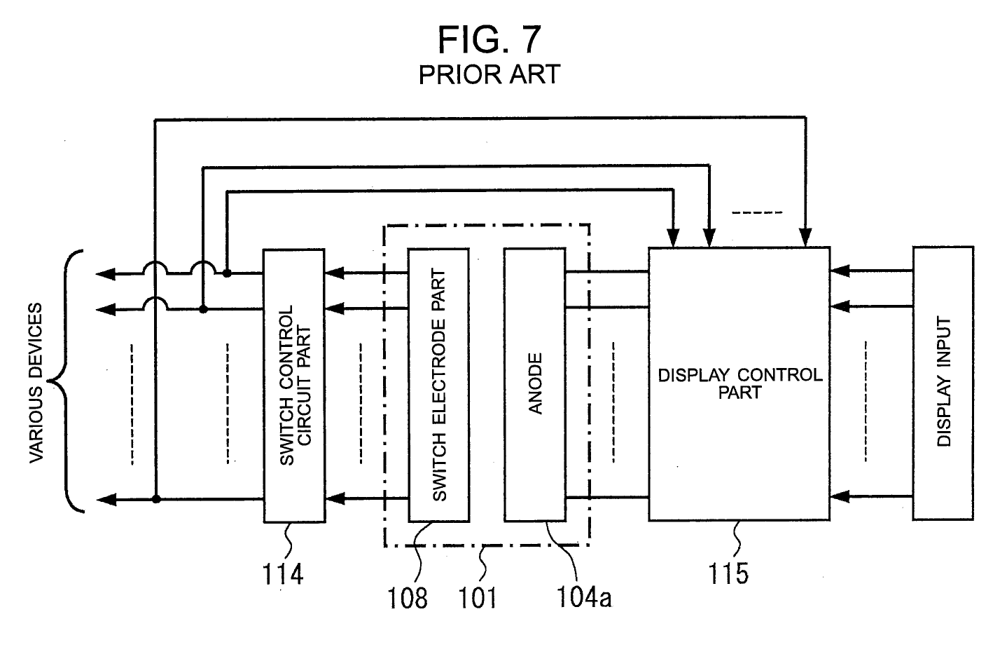

### DETAILED DESCRIPTION OF THE PREFERRED EMBODIMENTS

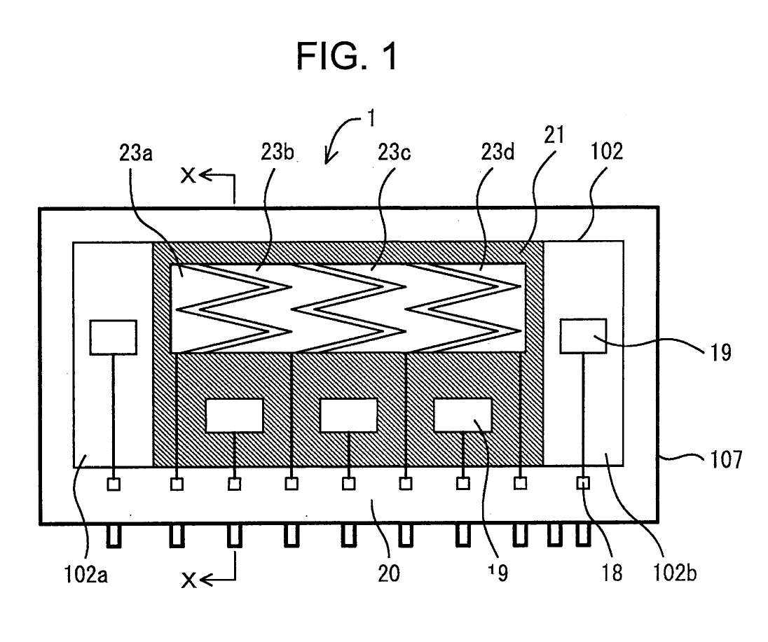

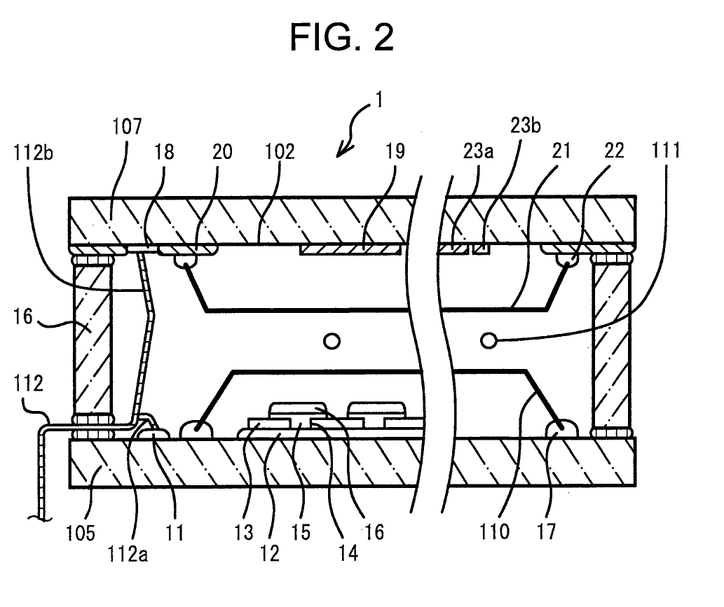

A fluorescent display device according to an embodiment of the present invention will be explained with reference to FIGS. 1 to 4. FIG. 1 is a front view showing a main part of a fluorescent display tube 1. FIG. 2 is a sectional view taken on line X-X of FIG. 1. In FIG. 2, a supporting structure of the filament cathode 111 is omitted.

In FIG. 2, a terminal part 11 on which a tip part 112a of the lead terminal 112 is touched and a wiring 12 electrically connected to the terminal part 11 are made of a metallic thin film and formed on the substrate 105. An insulating layer 13 is formed on the wiring 12, and a conductor 15 contacts the wiring 12 via a through-hole 14 of the insulating layer 13. A phosphor layer 16 covers a top wall of the conductor 15. The insulating layer 13, the conductor 15, and the phosphor layer 16 correspond to the pattern display part 104 in the prior art. A control electrode 110 is fixed to the substrate 105 with an electrically conductive adhesive 17 so as to cover the insulating layer 13, the conductor 15, and the phosphor layer 16. The control electrode 110 is connected to the terminal 112 with wiring (not shown).

A terminal part 18 on which a tip part 112b of the lead terminal 112 is touched and a switch electrode 19 electrically connected to the terminal part 18 are made of a metallic thin film and formed on the front plate 107. The metallic thin film is made by sputtering material such as aluminum, or niobium, and by etching to form a specific pattern. The switch electrode 19 is composed of a rectangular frame having a line width of about twenty to thirty micron, and stripe-shaped or mesh-shaped narrow lines having a line width of about twenty to thirty micron arranged in the frame with fifty to sixty micron intervals.

A specific range from an end of an inner wall of the front plate 107 is covered with a light-blocking and insulating crossover layer 20 except the terminal 18. An inside of the crossover layer is the display window 102. Preferably, the display window 102 has enough space to see the pattern display part 104. The switch electrode 19 is provided on a part of the display window 102. A shield electrode 21 is fixed to the crossover layer 20 with an electrically conductive adhesive 22 so as to cover the display window 102. The shield electrode 21 is connected to the lead terminal 112 with wiring (not shown) via the terminal part 18 and the tip part 112b. The filament cathode 111 is interposed between the shield electrode 21 and the control electrode 110.

The crossover layer 20 is formed by printing and burning a paste composed of a black-pigment-mixed low-softening-temperature glass frit. A mesh made of stainless steel or nickel-chromium alloy having a thickness of about fifty micron similar to the control electrodes 110 of the fluorescent display tube 1 is used as the shield electrode 21. The electrically conductive adhesive 22 is made of a mixture composed mostly of a powdered metal, such as aluminum, and a low-softening-temperature glass frit.

In the front view of FIG. 1, the crossover layer 20 is extended all around the front plate 107 in a specific width from an edge of the front plate 107, and the display window 102 is formed in an inside of the crossover layer 20. Because the electrically conductive adhesive 22 fixing the shield electrode 21 is disposed at a rear of the crossover layer 20, the electrically conductive adhesive 22 cannot be seen from a front side of the fluorescent display tube 1. The shield electrode 21 is provided on the display window 102 except both ends of the display window 102. This corresponds to a whole area in which the shield electrode 21 can be extended and the pattern display part 104 can be formed. Areas 102a, 102b which are not covered with the shield electrode 21 are the areas on which supporters supporting the filament cathode 111 are provided, thereby no display can be displayed on the areas 102a, 102b.

In FIG. 1, a linear switch 23 composed of four linear switch electrodes 23a to 23d which outputs, for example, with a 128-position resolution and three switch electrodes 19 are provided on an area of the shield electrode 21. A behavior of the linear switch 23 is described later. A switch electrode 19 is provided in each of the display windows 102a, 102b.

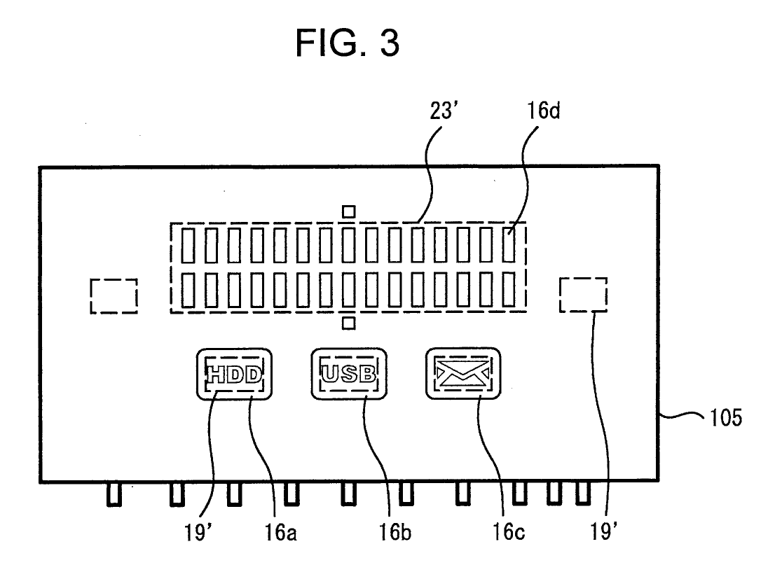

FIG. 3 shows a physical relationship between these switch electrodes 19 and patterns of the phosphor layer 16 provided on the pattern display part 104. In FIG. 3, a phosphor pattern 16a indicating a word “HDD”, a phosphor pattern 16b indicating a word “USB”, a phosphor pattern 16c indicating a symbol of “mail”, and a phosphor pattern 16d indicating a bar graph are provided over the substrate 105. Boxes composed of a dashed line 19′ indicate positions of the switch electrodes 19, and a box composed of a dashed line 23′ indicates a position of the linear switch 23.

Each time when an operator's finger touches the outer wall 107a upon the switch electrode 19 on the phosphor layer 16, the electrostatic capacitor of the switch electrode 19 is changed. The change is judged and outputted by the switch control circuit part 114, and the display control part 115 receives the output and turns on/off the light of the phosphor layer 16.

Further, when an operator's finger touches the outer wall 107a upon the linear switch 23, an output from the linear switch 23 is continuously changed corresponding to the touching position to vary a lighting area of the bar graph. The output can be also used to adjust a volume of a speaker which is simultaneously used with the fluorescent display tube 1.

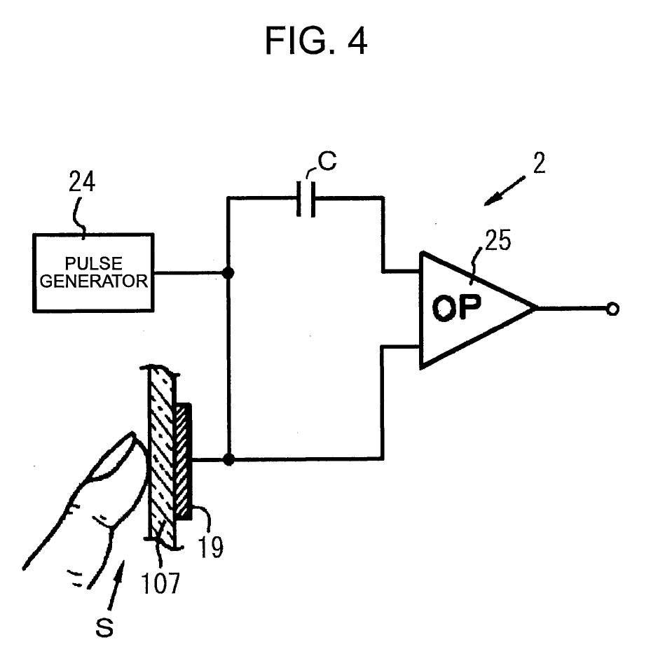

An operating principle of a touch switch according to the present invention will be explained with reference to FIG. 4. A switch control circuit 2 includes a pulse generator 24, a comparator 25, and a capacitor C interposed between one of inputs of the comparator 25 and the pulse generator 24. The switch electrode 19 is connected to the pulse generator 24 and to another input of the comparator 25.

When the operator's finger touches the outer wall 107a (touching point S) on the switch electrode 19, an electrostatic capacitor is generated between the finger and the switch electrode 19 as a kind of a capacitor. The capacitor C corresponds to the electrostatic capacitor of the switch electrode 19 on which the finger is not touched.

When the operator's finger touches the touching point S, the finger works as a dielectric body, and the electrostatic capacitor of the switch electrode 19 is changed. Then, a balance between the electrostatic capacitors of the switch electrode 19 and the capacitor C breaks down, and pulse voltages applied to both inputs of the comparator 25 become different from each other, and an output is outputted from the comparator 25.

In the linear touch switch 23, electrodes at the both ends 23a, 23d are connected to a common line, and the electrodes 23b, 23c are connected to independent lines, and the electrodes are used as three sets of electrodes. These sets are respectively driven by wave signals each having substantially the same amplitude and shifted by 120 degree.

The additional electrostatic capacitor formed by touching the outer wall 107a with the operator's finger is changed corresponding to the position of the finger, and the phase of the signal generated from the electrode under the outer wall 107a is changed corresponding to the position of the finger touching the outer wall 107a.

This signal is inputted to the switch control circuit part 114, and predetermined display data is outputted to the display control part 115 based on this signal, and a display on the fluorescent display tube 1 is changed. A drive circuit and the like of this linear touch switch is already known by Japanese Published Patent Application No. S56-1438 and the like, and an explanation of these is omitted here.

Incidentally, the electrostatic capacitor type touch switch used in the present invention is not limited to the switch described in this embodiment, and various touch switches in the prior art can be used. Further, a well-known display control circuit using a microprocessor and a driver can be used as the display control circuit in the present invention.

An operating condition of the touch switch when an electric potential applied to the shield electrode 21 is changed will be explained. A structure of an assessed sample is that a height from an inner wall of the substrate 105 to the control electrodes 110 is about 0.5 mm, a height to the filament cathode 111 is about 1.5 mm, a height from an inner wall of the front plate 107 to the shield electrode 21 is about 0.5 mm, and a height to the filament cathode 111 is about 1.5 mm.

While 5 volts is applied to the filament cathode 111, 45 volts is applied to the control electrodes 110 and the wiring 12, and the voltage potential of the shield electrode 21 is changed from 0 to 20 volts, when the electric potential of the shield electrode 21 is over 10 volts, an operation of the touch switch using the switch electrode 19 becomes unstable.

This is believed that when the electric potential of the shield electrode 21 is higher than the electric potential of the filament cathode 111, an electron beam irradiates the switch electrode 19. Accordingly, preferably, the electric potential of the shield electrode 21 is the same as or lower than that of the filament cathode 111. This unstable operation is more notable in the linear switch which detects more strictly the position of the operator's finger.

### Embodiment 1

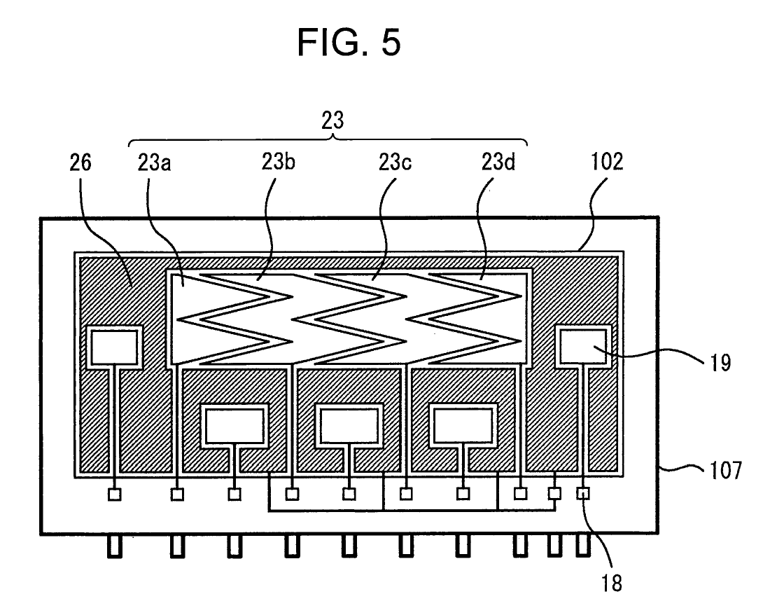

An embodiment of the present invention will be explained with reference to FIG. 5. In FIG. 5, the display window 102 is covered by a dummy pattern 26 except the switch electrode 19, a wiring connecting the switch electrode 19 and the terminal part 18, the linear switch electrodes 23a to 23d, and wirings connecting the linear switch electrodes 23a to 23d and the terminal parts 18.

Similar to the switch electrode 19, the dummy pattern 19 is formed by arranging the stripe-shaped or mesh-shaped narrow lines having a line width of about twenty to thirty micron with fifty to sixty micron intervals. Preferably, the dummy pattern is produced in the same process as the switch electrode 19, and a pattern design of the dummy pattern is the same as the switch electrode 19.

### Embodiment 2

As another embodiment of the present invention, a fluorescent display tube having the switch control circuit part 114 and the display control part 115 will be explained. Recently, so-called chip-in-glass fluorescent display tube in which a plurality of driver ICs are assembled on the substrate 105 has been known.

According to the present invention, not only a driver IC but also ICs of the switch control circuit part 114 and the display control part 115 can be assembled on the substrate 105 of the fluorescent display tube 1. Thus, a smaller fluorescent display tube module can be realized than a module in which the switch control circuit part 114 and the display control part 115 are assembled on a print circuit board.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A fluorescent display device comprising:
a fluorescent display tube having
an envelope having a front plate with at least partially a display window,
a filament cathode for emitting electrons,
anodes on which a phosphor, which is excited and exhibits luminescence by an electron, is coated, said anodes being selectable corresponding to display data,
a touch switch portion formed on an inner wall of the display window of the front plate, and
a shielding electrode interposed between the filament cathode and the touch switch portion;
a switch control part electrically connected to the touch switch portion for outputting the display data corresponding to an input from the touch switch portion; and
a display control part.

2. The fluorescent display device as claimed in claim 1, wherein the shielding electrode is a mesh-shaped metallic electrode.

3. The fluorescent display device as claimed in claim 1, wherein the shielding electrode is fixed to the front plate at around the display window.

4. The fluorescent display device as claimed in claim 1,wherein the same electric potential as applied to the filament cathode or the lower electric potential than that applied to the filament cathode is applied to the shielding electrode.

5. The fluorescent display device as claimed in claim 1,wherein the touch switch portion is made of a stripe-shaped or mesh-shaped metallic thin film electrode.

6. The fluorescent display device as claimed in claim 1, wherein a dummy electrode electrically independent from the touch switch portion and covering the display window is formed around the touch switch portion.

7. The fluorescent display device as claimed in claim 6,wherein the electric potential of the dummy electrode is fixed to the predetermined electric potential.

8. The fluorescent display device as claimed in claim 1, wherein the touch switch portion includes four electrodes indented each other, and detects electrostatic capacity in a manner that the electrodes at both ends are in the same phase, and the other electrodes are in phases respectively shifted 120 degree.

9. A fluorescent display tube comprising:
an envelope having a front plate with at least partially a display window;
a filament cathode for emitting electrons;
anodes on which a phosphor, which is excited and exhibits luminescence by an electron, is coated, said anodes being selectable corresponding to display data;
a touch switch portion formed on an inner wall of the display window of the front plate for outputting a signal to a switch control circuit; and
a shielding electrode interposed between the filament cathode and the touch switch portion.

10. The fluorescent display tube as claimed in claim 9, wherein the shielding electrode is a mesh-shaped metallic electrode.

11. The fluorescent display tube as claimed in claim 9, wherein the shielding electrode is fixed to the front plate at around the display window.

12. The fluorescent display tube as claimed in claim 9, wherein the same electric potential as applied to the filament cathode or the lower electric potential than that applied to the filament cathode is applied to the shielding electrode.

13. The fluorescent display tube as claimed in claim 9, wherein the touch switch portion is made of a stripe-shaped or mesh-shaped metallic thin film electrode.

14. The fluorescent display tube as claimed in claim 9, wherein a dummy electrode electrically independent from the touch switch portion and covering the display window is formed around the touch switch portion.

15. The fluorescent display tube as claimed in claim 14, wherein the electric potential of the dummy electrode is fixed to the predetermined electric potential.

16. The fluorescent display tube as claimed in claim 9, wherein the touch switch portion includes four electrodes indented each other, and detects electrostatic capacity in a manner that the electrodes at both ends are in the same phase, and the other electrodes are in phases respectively shifted 120 degree.

17. A fluorescent display tube comprising:
an envelope having a front plate with at least partially a display window;
a filament cathode for emitting electrons;
anodes on which a phosphor, which is excited and exhibits luminescence by an electron, is coated, said anodes being selectable corresponding to display data;
a touch switch portion formed on an inner wall of the display window of the front plate;
a shielding electrode interposed between the filament cathode and the touch switch portion; and
a switch control part electrically connected to the touch switch portion for outputting the display data corresponding to an input from the touch switch portion and a display control part disposed in the envelope.

18. The fluorescent display tube as claimed in claim 17, wherein the shielding electrode is a mesh-shaped metallic electrode.

19. The fluorescent display tube as claimed in claim 17, wherein the shielding electrode is fixed to the front plate at around the display window.

20. The fluorescent display tube as claimed in claim 17, wherein the same electric potential as applied to the filament cathode or the lower electric potential than that applied to the filament cathode is applied to the shielding electrode.

21. The fluorescent display tube as claimed in claim 17, wherein the touch switch portion is made of a stripe-shaped or mesh-shaped metallic thin film electrode.

22. The fluorescent display tube as claimed in claim 17, wherein a dummy electrode electrically independent from the touch switch portion and covering the display window is formed around the touch switch portion.

23. The fluorescent display tube as claimed in claim 22, wherein the electric potential of the dummy electrode is fixed to the predetermined electric potential.

24. The fluorescent display tube as claimed in claim 17, wherein the touch switch portion includes four electrodes indented each other, and detects electrostatic capacity in a manner that the electrodes at both ends are in the same phase, and the other electrodes are in phases respectively shifted 120 degree.
